(19) United States
(12) Patent Application Publication
(10) Pub. No.: US 2011/0225408 A1
(43) Pub. Date: Sep. 15, 2011

(54) CACHE BOOT MECHANISM

(76) Inventors: Ren Guo, Hangzhou (CN); Xiaobing Yu, Hangzhou (CN); Huajiang Xu, Hangzhou (CN)

(21) Appl. No.: 12/721,491

(22) Filed: Mar. 10, 2010

(51) Int. Cl. G06F 15/177; G06F 12/00; G06F 12/08

(52) U.S. Cl. 713/2; 711/113; 711/E12.001; 711/E12.019

(57) ABSTRACT

A block device driver performs system boot using cache data and thus provides a mechanism that reduces disk/IO waiting time during system boot.

### BACKGROUND OF THE INVENTION

1. Technical Field

The invention relates to personal computer systems. More particularly, the invention relates to a cache boot mechanism.

2. Description of the Prior Art

Many personal computer systems require more than 60 seconds to boot. This boot time is unacceptable for instant-on solutions. Among the various factors that affect boot time is the disk I/O waiting time during system boot. Accordingly, it would be desirable to provide a mechanism that reduces disk/IO waiting time during system boot.

### SUMMARY OF THE INVENTION

One embodiment of the invention provides a block device driver to accomplish system boot using cache data. This mechanism improves computer boot time by reducing disk I/O (Input/Output) waiting time during system boot. This embodiment also can replace the traditional loop block device driver, can co-exist with the loop block device driver, and can perform a standard block device driver role.

### BRIEF DESCRIPTION OF THE DRAWINGS

FIG. 1 is a block diagram that shows the difference between a normal boot sequence and a cache boot sequence for the Linux OS according to the invention;

FIG. 2 is a flow diagram that shows a mechanism for producing cache data according to the invention;

FIG. 3 is a block schematic diagram that shows how the boot cache data is loaded according to the invention;

FIG. 4 is a flow diagram that shows the cache boot data flow according to the invention; and

FIG. 5 is a block diagram that shows the system architecture according to the invention;

FIG. 6 is a flow diagram that shows a routine which puts all devices' BIO (Block Input Output) request package to a FIFO that is used as a BIO request FIFO according to the invention;

FIG. 7 is a block schematic diagram of a machine in the exemplary form of a computer system within which a set of instructions for causing the machine to perform any of the herein disclosed methodologies may be executed.

### DETAILED DESCRIPTION OF THE INVENTION

One embodiment of the invention provides a sector based caching system that improves system and application launch time. It utilizes a block device driver to accomplish system boot using cached data. This mechanism improves computer boot time by reducing disk I/O (Input/Output) waiting time and hard drive/flash initialization time during system boot. This embodiment of the block device driver also can replace the traditional loop block device driver, can co-exist with the loop block device driver, and can perform a standard block device driver role.

### Cache Boot

An embodiment of the invention provides a mechanism that effects a boot environment for a computer operating system, such as the Linux operating system (OS). One aspect of the invention makes system boot and application launch faster. According to the inventor's investigations, the Linux OS does not need to access all data in the hard drive during boot time. All required data or the sectors where the necessary data is stored can be found during the boot time procedure. One aspect of the invention takes advantage of this procedure to prepare cached data for the next boot. In addition, the Linux OS generally has a First Time Wizard procedure that runs when the system is booted for the first time which can be used to prepare the cached data as well. Based on this approach, we have invented a new block device driver to accomplish system boot using cached data. This mechanism for system booting is referred to herein as “Cache Boot.”

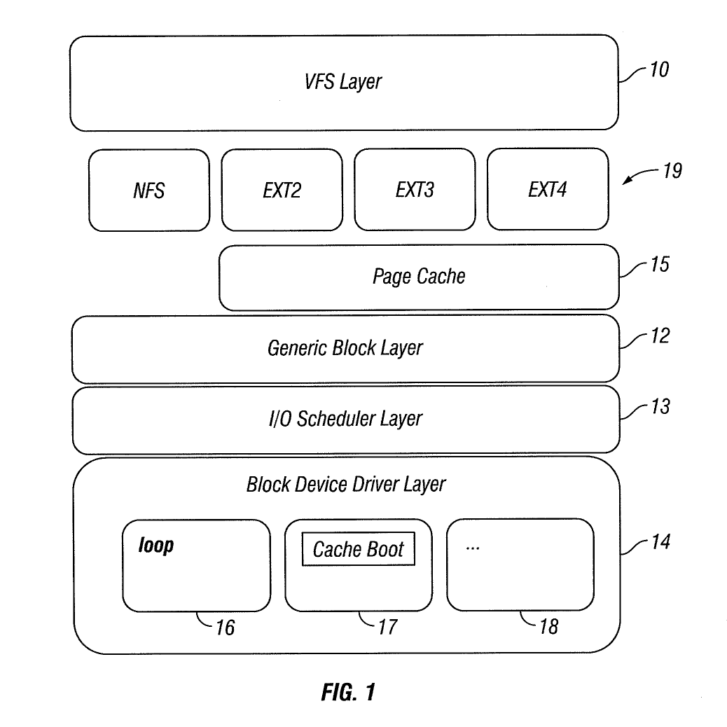

FIG. 1 is a block diagram that shows the difference between a normal boot sequence and a cache boot sequence for the Linux OS according to the invention. As shown in FIG. 1, a normal boot sequence 34 involves a computer system having a memory area 31 that includes the Linux OS having a normal block device driver, and a hard disk area 32 which includes block device data on a hard disk 30a. The cache boot sequence 36 includes the Linux OS but with a cache data block device driver 38 and a cache data mechanism 39, both of which reside in the memory area 31, while the block device data resides on the hard disk 30b in the hard disk area 32.

The cache boot mechanism can only add a cache data function that is beyond the normal boot. The following discussion describes the mechanism in greater detail.

### Producing the Cache Boot Driver

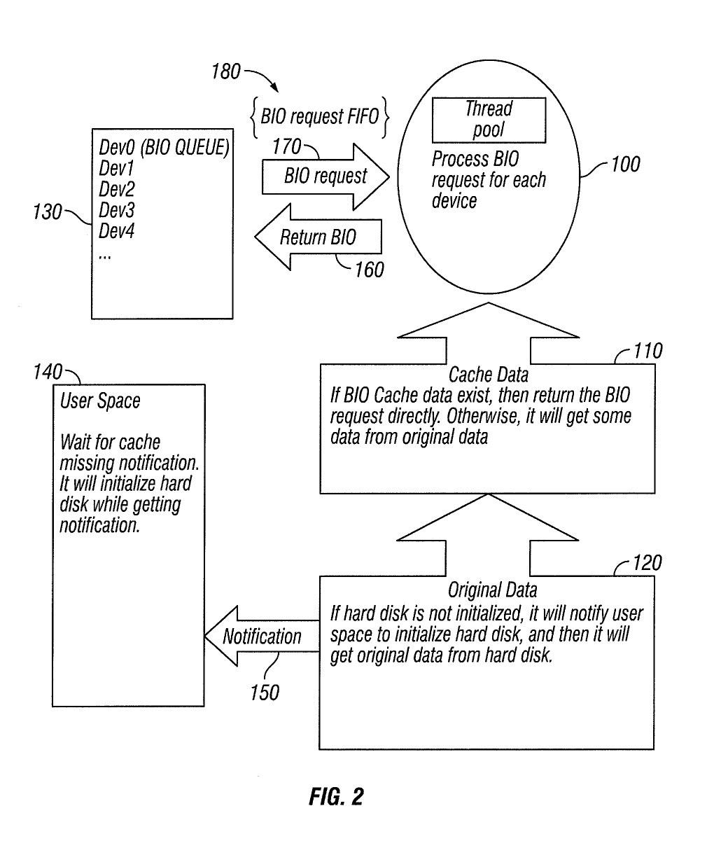

FIG. 2 is a flow diagram that shows a mechanism for producing cache data according to the invention. In one embodiment of the invention, the cache boot mechanism comprises a block device driver that can replace the loop device driver and perform the same function as the loop device driver. As shown in FIG. 2, a cache boot daemon program stores a cache boot driver record sector log and creates the boot cache data from the log. (200). Thus, the cache boot daemon produces a log file during the booting procedure that saves the related sector location and size. The cache boot daemon then produces cache data according to the log file during system idle time. The cache boot daemon triggers the boot finish (210) when the system is booting and the cache boot daemon is creating the sector log (220). In the event a power off event has occurred, the boot process waits until the cache boot daemon is finished (240) with a wait interval (230).

### Cache Boot Data Loading

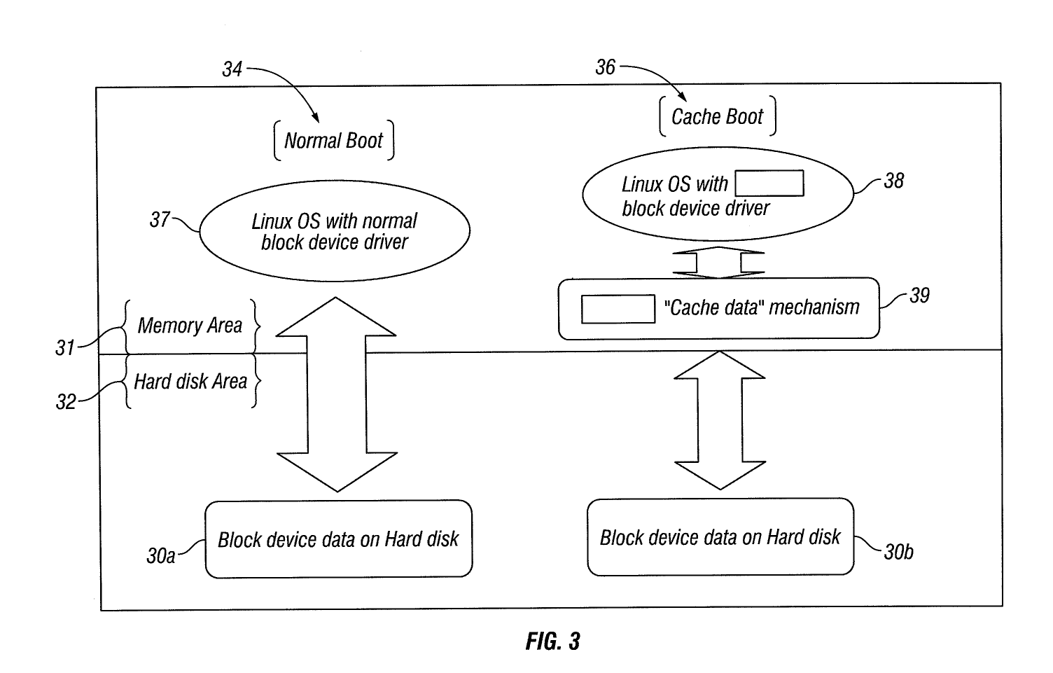

FIG. 3 is a block schematic diagram that shows how the cache boot data is loaded according to the invention. Before system boot up, the kernel 50 and file system 52 have been loaded to memory, and cache data 54 is appended at the end of file system. It is not necessary to access the hard disk to get data while booting the system, but it is only necessary to read cache data from memory. Accordingly, it is not necessary to wait for any I/O operations while booting the system.

### Cache Boot Data Flow

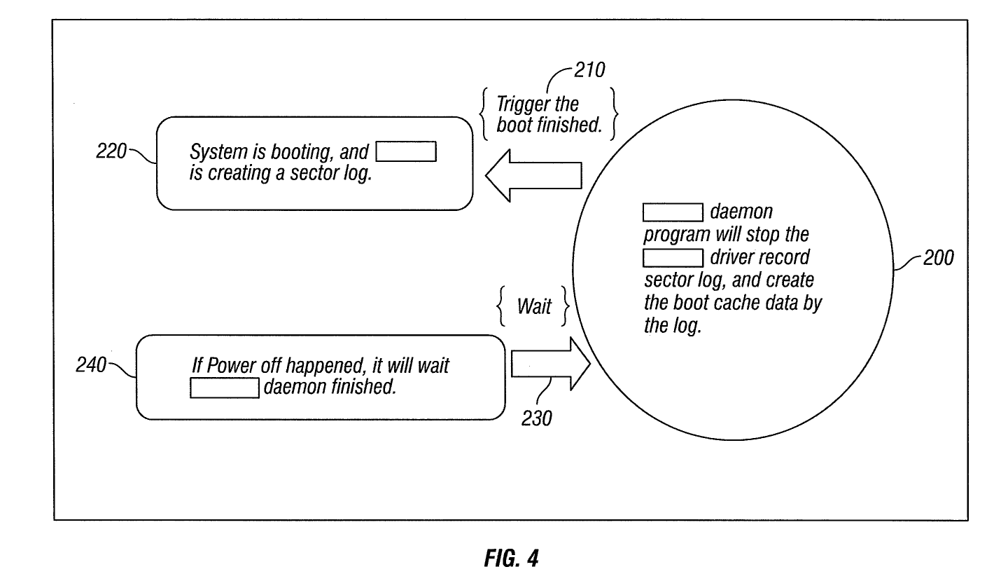

FIG. 4 is a flow diagram that shows cache boot data flow according to the invention. At the start of the flow, the boot loader reads the kernel, the file system, and the cache data (300). System booting begins (310). If the cache boot driver detects cache data during the system booting process (320), the cache boot driver uses this data to set logical block device interfaces (340), and the operating system mounts the file system with a virtual logic block device interface (350). This includes kernel thread processing. It is not necessary to perform hard disk initialization at this time.

If cache data is not found, the system initializes the hard disk and reads the real data from hard disk to the logical block device interface (330) and kernel thread processing continues (350).

The cache boot driver can seek data after cache data is found. If the requested cache data is found, the sector request is returned to the upper block layer with the cache data (380) and processing continues (390).

If data is not found (350) and the block device data is not set (360), the cache boot driver generates a sector fault, which is similar to a page fault for a virtual memory mechanism, and then it joins an exception handling procedure as follows:
1) Load disk controller driver.
2) Initialize the hard disk (330).
3) Seek block device data in hard disk (370).
4) Set the block device data to the cache boot driver.
5) Return the sector to upper layer (380).
6) Resume from exception handling, continue to the next sector request (390).

In general, the cache data is now complete, except that the system has been updated. Thus, the system initializes that hard disk after the desktop is ready.

### File Based Block Device Driver

An embodiment of the invention uses a thread pool to process all block devices, instead of creating a thread for each block device. Thus, one thread can serve more than one block device. This approach optimizes the thread model, compared with the loop device driver, and thus saves system resources.

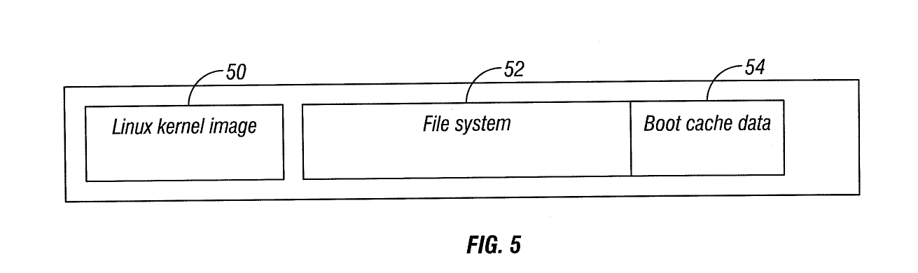

FIG. 5 is a block diagram that shows the system architecture according to the invention. Such architecture is representative of a typical system architecture, but is provided for example only, and the invention is not limited to this specific architecture. The architecture includes a VFS layer 10 above a functional layer 19 that includes such features, for example, as NFS, EXT2, EXT3, and EXT4. A page cache 15 is then followed by a generic block layer 12, and thence an I/O scheduler layer 13. Finally, the architecture includes a block device driver layer 14.

In this embodiment, a boot driver module 17 is provided in the block device driver layer, i.e. at the same system level as the loop block device driver 16 or other block device drivers 18. An embodiment of the invention provides a boot environment without the need for hard disk access during the OS boot. Thus, the system does not need to load the driver of the hard disk during boot time. Instead, the system uses cache data to boot. In a real world application of the invention, if the system has been changed, such as the result of adding an upgrade or new packages, then cache missing can occur in certain cases while using such cache data. In this situation, the system loads the hard disk driver to read real data from the hard disk. This mechanism can be thought of as a backup or failover feature of the invention.

### Thread Model

A generic block layer provides common APIs for processing the block sector I/O request in Linux OS. An embodiment of the invention also provides a normal block device driver, and thus must follow the APIs to implement a call back routine for the Linux OS.

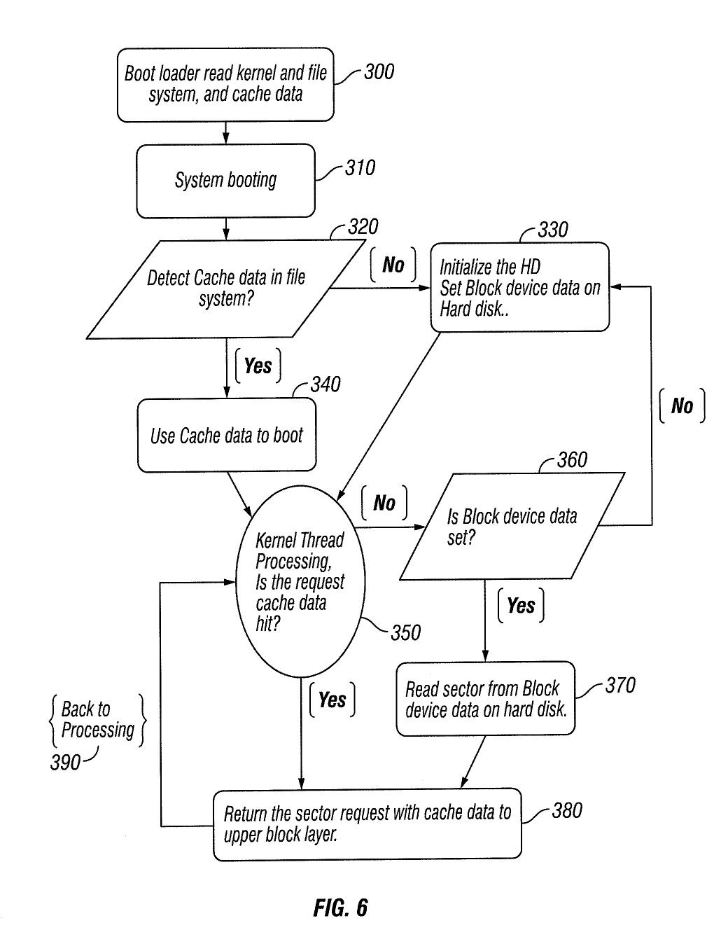

FIG. 6 is a flow diagram that shows a routine that puts all devices' BIO (Block Input Output) request packages to a FIFO that is used as a BIO request FIFO according to the invention. As mentioned above, the invention provides a mechanism that works with a thread pool model. The thread number can be specified. All threads handle the same FIFO no matter what number is specified. In FIG. 2, a device queue (130) includes a BIO QUEUE. The BIO request FIFO (180) processes both a BIO request (170) and a BIO return (160). The BIO request is presented to the thread pool (100) which processes the BIO request for each device. In doing so, cache data is accessed (110). If BIO cache data exists, then the BIO request is returned directly. Otherwise, data is obtained from the original data. The access to the original data (120) proceeds in this latter case. If the hard disk is not initialized, the user space is notified (150) to initialize the hard disk (140). The user space waits for a cache missing notification and, upon receiving such notification, initializes the hard disk. The original data is then provided from the hard disk.

### Computer System

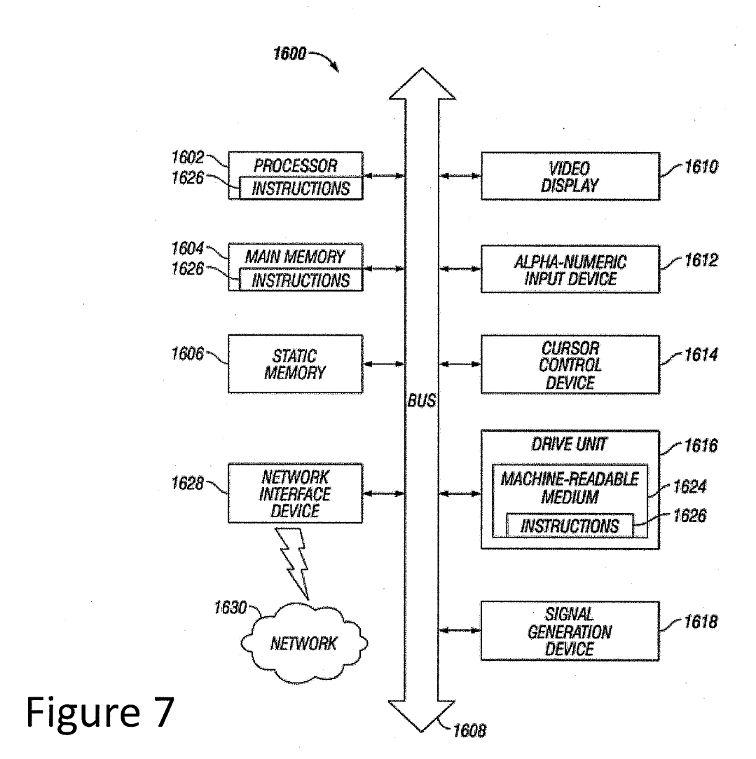

FIG. 7 is a block schematic diagram of a machine in the exemplary form of a computer system 1600 within which a set of instructions for causing the machine to perform any of the foregoing methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling. costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction. Other alternatives include a digital signal processing chip

(DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices;

electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for providing a boot environment for a computer system, comprising the steps of:
providing a boot driver module in a block device driver layer of said computer system; and
said boot driver module using cache data to execute a boot sequence of said computer system;
wherein said computer system's operating system (OS) boot sequence is executed in response to access to said cache data and without access to a computer system hard disk or flash drive.

2. The method of claim 1, further comprising the step of:
a boot loader accessing said hard disk and I/O to load said cache data to memory prior to executing said OS boot sequence.

3. The method of claim 1, further comprising the step of:
said computer system loading a hard disk driver to read data from said hard disk if cache missing occurs while using said cache data.

4. The method of claim 1, further comprising the step of:
using a thread pool to process all block devices, instead of creating a thread for each block device, wherein one thread serves more than one block device.

5. The method of claim 4, further comprising the steps of:
providing a BIO (Block Input Output) request FIFO (First In First Out);
said BIO request FIFO processing at least one BIO request and at least one corresponding BIO return;
presenting a BIO request to said thread pool, said thread pool processing said BIO request for each device;
accessing cache data; and
if BIO cache data exists, then returning said BIO request

6. The method of claim 5, further comprising the steps of:
if BIO cache data does not exist, then obtaining data from original data on said computer system hard disk;
if said computer system hard disk is not initialized, then notifying a user space to initialize said computer system hard disk, said user space waiting for a cache missing notification and, upon receiving said notification, said user space initializing said computer system hard disk; and
returning said original data from said computer system hard disk.

7. A method for executing a boot sequence for a computer system, comprising the steps of:
providing a block device driver comprising computer code that executes a computer system boot sequence using cache data;
accessing said cache data block device driver to commence said computer system boot sequence; and
executing said computer system's operating system (OS) boot sequence with said cache data.

8. The method of claim 7, further comprising the step of:
a boot loader accessing said hard disk and I/O to load said cache data to memory prior to executing said OS boot sequence.

9. The method of claim 7, wherein said computer system implements an operating system, wherein said operating system comprises the Linux operating system.

10. A method for producing boot cache data for use during a computer system boot sequence, comprising the steps of:
providing a block device driver comprising a cache boot daemon program;
storing a cache boot driver record sector log; and
creating boot cache data from said record sector log;
wherein said cache boot daemon produces said log file during said computer system boot sequence that saves related sector location and size; and
wherein said cache boot daemon produces cache data according to said log file during system idle time;
said cache boot daemon triggering a boot sequence when said computer system is booting and while said cache boot daemon is creating said sector log.

11. A method for loading cache boot data for use during a computer system boot sequence, comprising the steps of:
before starting a computer system boot sequence, loading a kernel and a file system into a computer system memory; and
appending cache data at an end of said file system.

12. The method of claim 11, further comprising the steps of:
reading cache data from memory during a computer system boot sequence;
wherein access to a computer system hard disk (OS) or I/O device is not necessary during said computer system's operating system boot sequence; and
wherein it is not necessary to wait for I/O operations during said computer system's operating system boot sequence.

13. The method of claim 12, further comprising the step of:
a boot loader accessing said hard disk and I/O to load said cache data to memory prior to executing said OS boot sequence.

14. A method for effecting a computer system boot sequence using cache boot data, comprising the steps of:
a boot loader reading a computer system kernel, file system, and cache data;
said computer system beginning said boot sequence;
if a cache boot driver detects said cache data during said computer system boot sequence, said cache boot driver using said cache data to set a logical block device interface; and
said computer system operating system mounting said file system with a virtual logic block device interface and effecting kernel thread processing without performing hard disk initialization.

15. The method of claim 14, wherein said boot loader comprises any of a BIOS (Basic Input Output System), an EFI (Extensible Firmware Interface), A UEFI (Unified EFI), embedded OS, or a common boot loader.

16. The method of claim 14, further comprising the step of:
if said cache boot driver does not detect cache data, said computer system initializing said hard disk and reading data from said hard disk to said logical block device interface, wherein kernel thread processing continues.

17. The method of claim 14, further comprising the step of:
said cache boot driver seeking data after cache data is found and returning a sector request to an upper block layer with said cache data.

18. The method of claim 17, further comprising the step of:
if data is not found and said block device data is not set, said cache boot driver generating a sector fault and joining an exception handling procedure.

19. The method of claim 14, said exception handling procedure comprising the steps of:
loading a disk controller driver;
initializing said hard disk;
seeking block device data in said hard disk;
setting block device data to said cache boot driver;
returning a sector to an upper layer;
resuming from exception handling; and
continuing to a next sector request.

20. A boot environment for a computer system, comprising:
a boot driver module stored in a block device driver layer of said computer system; and
a cache having stored therein cache data that is used by said boot driver module to execute a boot sequence of said computer system without access to a computer system hard disk.
